(19) United States
(12) Patent Application Publication
(10) Pub. No.: US 2002/0147275 A1
(43) Pub. Date: Oct. 10, 2002

(54) Two-step curable mixer-suitable materials

(76) Inventors: Alexander Bublewitz, Herborn (DE); Jens-Peter Reber, Herborn (DE); Ulrich Nagel, Tubingen (DE)

Correspondence Address: JACOBSON HOLMAN PLLC, 400 SEVENTH STREET N.W., SUITE 600, WASHINGTON, DC, 20004, US

(21) Appl. No.: 09/808,412

(22) Filed: Mar. 15, 2001

(30) Foreign Application Priority Data
Jan. 25, 2001 (DE) 101 03 446.6

(51) Int. Cl. C08F 8/00

(52) U.S. Cl. 525/100

(57) ABSTRACT

The present invention relates to a multi-component system for making impressions comprising at least two components A and B, characterized in that component A contains

(a) at least one compound having at least two alkenyl groups;

(b) at least one compound having at least one alkynyl group and/or at least one compound having at least one Si—OH structural unit; and

(c) at least one organohydrogenpolysiloxane;

and component B contains

(d) at least one condensation catalyst and/or condensation cross-linking agent; and

(e) at least one hydrosilylation catalyst.

After the mixing of the components, the materials according to the invention cure in two steps. After mixing, the mixture, in a first state, has a mixer-suitable consistency, whereupon the mixture undergoes transition to a heavier-bodied second state due to condensation reactions of SiOH groups and/or hydrosilylation reactions of alkynyl groups with SiH groups, followed by transition to a third solid, elastic state following curing through a hydrosilylation reaction of alkenyl groups with SiH groups. The invention also relates to mixtures and components comprising further ingredients, as well as methods for the preparation of impressions.

The present invention relates to multicomponent systems, components, mixtures and methods for making impressions. Addition-cross-linkabie silicones make use of the hydrosilylation, catalyzed by a (precious) metal (A), between a vinyl-end-stopped polydimethylsiloxane (B) and a polymethylhydrogensiloxane (C) to build a three-dimensional elastomeric network. This involves adding the SiH group of the polymethyihydrogensiloxane to the Si-vinyl group to form an ethylene bridge. Once the components A, B and C are brought into contact, the cross-linking reaction starts immediately. In order to provide user-oriented processing conditions, addition-cross-linkable silicones are stored as two-component materials in the form of separated components 1 and 2 and mixed together only shortly before use.

In addition to the vinylorganopolysiloxanes (B), component 1 contains the (precious) metal catalyst (A) (usually a platinum catalyst) necessary for the cross-linking reaction. Component 2 necessarily contains polymethylhydrogensiloxane (C) as a cross-linking agent and optionally vinylorganopolysiloxane.

For adjusting the pot life of these addition-cross-linkable two-component silicones, so-called inhibitors are employed which interfere in the catalytic cycle and thus control the reaction rate.

Examples of those inhibitors mentioned above are benzotriazole, ethynylcyclohexanol, short-chained vinyl-containing organopolysiloxanes, such as divinyltetramethyidisiloxane, and vinyl-containing cyclic siloxanes, such as tetravinyltetramethylcyclotetrasiloxane, diethyl maleate and n-octylsilane (C₈H₁₇SiH₉).

The cross-linking of the addition-cross-linkable silicones through hydrosilylation is very sensitive towards catalyst poisons, such as nitrogen, phosphorus or sulfur compounds, as occur in organic compounds, such as amino acids, or in latex gloves, for example. This means that the curing reaction is decelerated upon contact with such catalyst poisons, or even brought to subside in the worst case.

In technology, addition-cross-linkable silicones are widely employed for use as impression materials (e.g., in model-making), casting compositions for the electrical and automobile industries, and sealants for the construction and automobile industries (see Andreas Tomanek, “Silicone und Technik”, 1990, Hanser Verlag München; W. Noll, “Chemie und Technologie der Silicone”, 1968, Verlag Chemie; “Silicone: Chemie und Technologie”, 1989, Vulkan Veriag, Essen).

In dentistry, addition-cross-linkable silicones are successfully employed for making dental impressions, for checkbite recording and for the relining of dental prostheses.

When they are used as a material for making dental impressions, different shaping techniques can be employed:

monophase shaping (one phase and one time);

sandwich technique (two phases and one time);

dual mixing technique (two phases and one time);

correction shaping (two phases and at two different times).

In the sandwich and correction shaping techniques, two silicone impression materials having different mixing consistencies (ISO 4823) are employed.

In the first step, the impression tray is charged with a kneadable support material (putty), which, in a second step, is covered with a layer of a light-bodied silicone. In the sandwich technique, this is done simultaneously during the pot life of the two materials, followed by simultaneously applying the two materials in the patient's mouth.

In correction shaping, the kneadable putty material is made to cure as a preimpression material in the patient's mouth, trimmed after removing from the mouth, and in a second subsequent step, it is covered with a layer of a light-bodied material and again made to cure in the patient's mouth.

According to the prior art (Dr. Bernd Wortmann, Habilitationsschrift 1992, “Zum derzeitigen Stand der Abformung in der Zahnheilkunde”, University of Münster, Germany; J. Wirz, “Abformungen in der zahnärztlichen Praxis”, 1993, Gustav Fischer Veriag), the support material (putty) is predominantly employed in the form of a kneadable material. This has the advantage that a higher back pressure is generated in the impression tray when the Impression is made. In the sandwich technique, this causes the light-bodied correction material to flow into narrow cavities and the sulcus to ensure a highly precise shaping down to details.

When the preimpression for the correction shaping material is made, the kneadable support material, due to its viscous consistency, has the advantage of spreading less finely and thus reserving more space for the subsequent correction shaping steps using the light-bodied material.

In order to provide additional space for the correction material employed in the subsequent step, it may be necessary to trim the cured support material, i.e., in the preimpression, the shaped interdental spaces are cut off, and drainage channels are laid down.

This is the reason why the cured support material must be easy to trim, e.g., using a scalpel.

Otherwise, the support material would be deformed in this step (Prof. Dr. Wöstmann, University of GieBen, Germany: “Zum derzeitigen Stand der Abformung in der Zahnheilkunde”, Münster 1992).

However, the user of the support material (putty) used for the above mentioned shaping techniques must face the following disadvantages:

Dosage is effected with dosing spoons by means of which the kneadable material is removed from the storage cans clumsily and with a relatively high expenditure of force. Subsequently, the components, which are differently colored, are kneaded into a homogeneous compound using a mixing fork or manually, This procedure is also more or less complicated and, when a kneading fork is used, requires a high expenditure of force. This way of dosing and mixing may involve the following errors:

there is a risk of wrong dosage; and

there is a risk of non-homogeneous mixing of the two components.

Both factors lead to insufficient cross-linking so that the precision of model making is no longer ensured.

The dosing of kneadable preimpression materials (putties) involves the risk of contamination of the components with the respectively other component. From former experience, it is known that application errors cannot be avoided in spite of the color coding.

The dosing spoons or the covers of the containers of components 1 and 2 are often confused by the user, or he reaches into the storage can with contaminated fingers or gloves. Impression materials thus contaminated are no longer suitable for further use; for example, they contain cured regions in the form of lumps.

In the usual mixing of kneadable preimpression materials (putties) by hand, there is a risk that catalyst poisons may be extracted from the user's skin or protective gloves, which may lead to deceleration of the curing or even prevent curing of the impression material in the worst case.

In the market, so-called putty cartridge materials (e.g., Reprosil Quixx Putty, Dentsply Caulk) are known which can be processed with the commercially available mixing and dosing systems and which can be employed as an alternative of kneadable preimpression materials. These are light- to heavy-bodied materials according to ISO 4823, which exhibit a relatively high degree of cross-linking already during their pot life due to their rapid cross-linking characteristic. Consequently, the originally light- to heavy-bodied initial consistency is highly increased during the pot life and the user experiences the feeling of a putty material (high pressure) when the impression is being made.

These impression materials have the disadvantage that their total pot life to be used by the dentist is highly limited. When the predetermined pot lives are exceeded or when the ambient temperatures are slightly increased, there is a risk that the impression material has already formed large elastic fractions or, in an extreme case, has already cured so that the impressions are highly distorted by endogenous strains, restoring forces and compressions and are thus useless.

It has been the object of the present invention to provide mixer-suitable impression materials based on addition-cross-linkable polydimethylsiloxanes which, due to their light- to heavy-bodied mixing consistency in the initial phase, can be dispensed from the recently developed automatic mixing and dosing systems and, after having left the mixing and dosing device, due to their two-step reaction mechanism, undergo transition to a second mixing consistency with increased viscosity in a first reaction step after the mixing period.

In a second reaction step after a presettable pot life during which an impression is made, the impression material is to cure completely to an elastic final state in which a shaping result is recorded.

“Mixer-suitable impression material” means a multicomponent impression-material which can be dispensed, for example, from a two-component disposable cartridge through a static mixer, e.g., of Mixpac (Keller EP 0 615 787 A1, EP 0 730 913 A1) or from tubular film bags in dual-chamber reusable cartridges through a dynamic mixer, e.g., in the “Mixstar” device of DMG-Mühlbauer (PCT/EP 98/01993 and PCT/EP 98/01858) or in the “Pentamix I” and “Pentamix II” devices of Espe (EP-A-0 492 413 and EP-A-0 492 412).

The requirement of mixer-suitability can be met by impression materials which are in a consistency range of larger than 26 mm, especially larger than 30 mm, according to ISO 4823.

It has been the object of the present invention to provide an impression material which avoids the drawbacks set forth above and to provide a method which permits the preparation of impressions in a simple and reliable way from objects from which impressions are to be made. In particular, the object has been to provide a multi-component impression material which can be simply and readily mixed and is mixer-suitable, suitable for making impressions and undergoes transition to an elastic solid state.

These objects are surprisingly achieved by providing a multi-cornponent system for making impressions which contains

(a) at least one compound having at least two alkenyl groups;

(b) at least one compound having at least one alkynyl group and/or at least one compound having at least one Si-OH structural unit;

(c) at least one organohydrogenpolysiloxane;

(d) at least one condensation catalyst and/or condensation cross-linking agent; and

(e) at least one hydrosilylation catalyst.

It is preferred to provide a multi-component system for making impressions comprising at least two components A and B, wherein component A contains

(a) at least one compound having at least two alkenyl groups;

(b) at least one compound having at least one alkynyl group and/or at least one compound having at least one Si—OH structural unit; and

(c) at least one organohydrogenpolysiloxane;

and component B contains

(d) at least one condensation catalyst and/or condensation cross-linking agent; and

(e) at least one hydrosilylation catalyst.

Component A according to the invention may additionally contain

(f) inhibitors of the condensation reactions of metal alkoxides with compounds containing Si—OH structural units; and/or

(g) water-donating agents.

The components according to the invention, components A and/or B, may additionally contain

(h) desiccants;

(i) inert carrier materials;

(j) compounds for reaction inhibition of the hydroslylation reaction;

(k) reinforcing fillers;

(l) non-reinforcing fillers and/or

(m) auxiliaries.

The object of the invention is achieved by making use of a two-step reaction mechanism which is initiated upon mixing of components A and B and which relies on the different reactivities in the addition cross-linking of the alkenyl and alkynyl groups towards SiH groups and/or relies on the different reaction mechanisms in the addition cross-linking between alkenyl and SiH groups as compared to the condensation cross-linking of Si-OH groups with condensation catalysts.

Surprisingly, in the combination of the hydrosilylation reactions of Si-vinyl and Si-ethynyl groups, it is found that

a) the reactions proceed in successive periods of time and are thus suitable for use in two-step curable impression materials;

b) in a multicomponent, especially two-component, material, the reactants can be distributed on the individual components, e.g., in a dual-chamber cartridge or tubular film bag, in such a way that these are storage-stable at room temperature over a period of at least 12 months, i.e., do not exhibit any losses in reactivity.

Surprisingly, when the condensation reaction (hydroxypolysiloxane with condensation catalysts, such as titanic acid ortho esters) is combined with the hydrosilylation reaction (Si-vinyl and/or Si-ethynyl with organohydrogenpolysiloxanes in the presence of Pt catalysts), it is found that

a) the reactions proceed in successive periods of time when suitable inhibitors are employed;

b) the reactions proceed Independently, without the reactants having a negative effect on the reactivity of the respective other reactions;

c) in a multicornponent, especially two-component, material, the reactants can be distributed on the individual components, e.g., in a dual-chamber cartridge or tubular film bag, in such a way that these are storage-stable at room temperature over a period of at least 12 months, i.e., do not exhibit any losses in reactivity or deterioration of mechanical properties in the cured product;

d) the concentration range of the metal alkoxides employed can be selected in such a way that in practice, i.e., when used in cartridges and tubular film bags, obstruction of the exit channels due to “silicification” from access of atmospheric moisture does not occur.

The components are preferably selected in such a way that the condensation and hydrosilylation reactions occur at from 10 to 40° C., so that the reactions can be performed, in particular, at oral and room temperature.

In preferred embodiments, the aikynyl compound (b) of component A is

R¹—C═C—X—R²

and the Si—OH compound according to (b) is

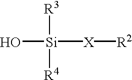

wherein

R¹ alkyl, aryl, arylalkyl, halogen-substituted alkyl and aryl groups, cyanoalkyl, cycloalkyl, cycloalkenyl, especially —H, —OH, alkoxy, acyl, and combinations thereof;

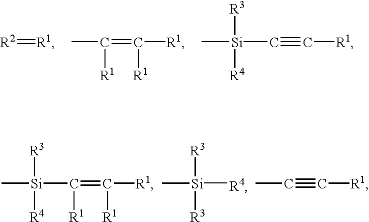

R³=alkenyl, alkynyl, halogen, aryl, alkylaryl, H, halogen-substituted alkyl and aryl groups, especially alkyl, alkoxy and hydroxy, and combinations thereof;

R⁴=R³, or R⁴ is different from R³, wherein R⁴ is, in particular, alkoxy, hydroxy, alkyl, methyl, alkynyl, ethynyl, or combinations thereof; and

X=polysiloxane, polyether, (monomeric, oligomeric or polymeric) hydrocarbons, polyesters and copolymers of the above mentioned compounds.

In the polymers, polymeric side chains and/or the residues R¹ and/or R² may be present. The chain may contain alkenyl or alkynyl groups.

Component A may additionally contain a compound of the structural formula

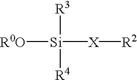

wherein

R⁰ is an acyl or alkyl residue; and

R², R³, R⁴ and X are as defined above.

Compounds of this type are preferably employed when Sn catalysts are contained in component B.

As compounds according to (b), component A may contain, in particular, those of the structural formula

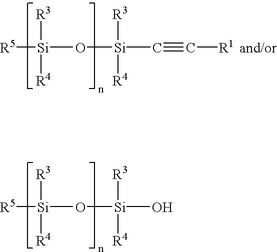

wherein n=0 to 6000;

R¹ to R⁴ are as defined above; and

R⁵—C═C—R¹, H, alkyl, aryl,

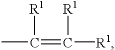

alkylaryl, halogen, OH, halogen-substituted alkyl and aryl groups, —OR⁰, aminoalkyl, epoxy, cyanoalkyl, cycloalkyl, alkylhydroxyl, methacrylate, acrylate, mercaptoalkyl, carboxylate, carboxyalkyl or succinic anhydride.

Preferred aikenyl compounds (a) of component A are those having the structure

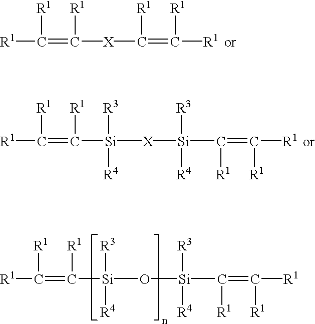

wherein n=0 to 6000; and

residues R¹, R², R³ and R⁴ are selected as set forth above.

The preferred alkenyl compound (a) may also be a silane dendrimer with terminal alkenyl groups.

Preferred organohydrogenpolysiloxanes (c) contained in component A include polyalkyl-, polyaryl- and polyalkylaryl-, polyhaloalkyl-, polyhaloaryl- or polyhalo-alkylarylsiloxanes. They may be in the form of oligomers or polymers in a linear or cyclic form and have at least one Si—H bond.

Condensation catalysts and/or condensation cross-linking agents (d) preferably employed in component B include aluminum alkoxides, antimony alkoxides, barium alkoxides, boron alkoxides, calcium alkoxides, cerium alkoxides, erbium alkoxides, gallium alkoxides, germanium alkoxides, hafnium alkoxides, indium alkoxides, iron alkoxides, lanthanum alkoxides, magnesium alkoxides, neodymium alkoxides, samarium alkoxides, strontium alkoxides, tantalum alkoxides, titanium alkoxides, tin alkoxides, vanadium alkoxide oxides, yttrium alkoxides, zinc alkoxides, zirconium alkoxides, titanium or zirconium compounds, especially titanic and zirconic acid ortho esters, and chelates and oligo- and polycondensates of the above alkoxides, dialkyltin diacetate, tin(II) octoate, dialkyltin diacylate, dialkyltin oxide and double metal alkoxides. Double metal alkoxides are alkoxides containing two different metals in a particular ratio. In particular, the following are employed: titanium tetraethylate, titanium tetrapropylate, titanium tetraisopropylate, titanium tetrabutylate, titanium tetraisooctylate, titanium isopropylate tristearoylate, titanium triisopropylate stearoylate, titanium dilsopropylate distearoylate, zirconium tetrapropylate, zirconium tetraisopropylate, zirconium tetrabutylate.

Hydrosilylation catalysts (e) preferably employed in component B include transition metals of the 8th auxiliary group, especially platinum, palladium and rhodium or their salts, complexes and colloids, preferably platinum complexes and salts of hexachloroplatinic acid, especially platinum(O)-1,3-divinyl-1,1,3,3-tetramethyldisiloxane complex.

Inhibitors of the condensation reactions (f) preferably employed in component A include α,ω-dihydroxydi-, -tri-, -oligo- and -polydialkylsiloxanes of general formula

HO—SiR₂—O—(SiR₂O)ₙ—SiR₃ or

HO—SiR₂—O—(SiR₂O)ₙ—SiR₂OH,

wherein R represents the same or different optionally substituted hydrocarbyl residues, such as alkyl, alkenyl, aryl or alkynyl, and n=0 or an integer of from 1 to 100.

Water-donating agents (g) preferably employed in component A include inorganic fillers containing superficially bound residual moisture or water bound in the crystal lattice, zeolites or purposefully moistened fillers or organic substances having a defined water content.

Preferred desiccants (h) in components A and/or B are zeolites, dried fillers or water-absorbing organic compounds, such as oxazolidines and alkali salts of poly(meth)acrylic acid (superabsorbers).

Inert carrier materials (i) preferably used include mineral oils, branched hydrocarbons, vaseline, esters, phthalic acid esters, acetyltributyl citrate, polyalkylene oxides and polyesters and their copolymers.

Compounds for reaction inhibition of the hydrosilylation reaction (j) preferably employed include short-chained organopolysiloxanes of general formula

CH₂═CH—SiR₂O—(SiR₂O)ₙ—SiR₂—CH═CH₂,

wherein R represents the same or different optionally substituted hydrocarbyl residues, such as alkyl, alkenyl, aryl, alkynyl, alkenyl, and alkynyl-terminated siloxane residues; and

n=0 or an integer of from 1 to 6.

Vinyl-containing cyclic siloxanes, such as tetravinyltetramethylcyclotetrasiloxane, or organic hydroxy compounds containing terminal double or triple bonds, diethyl maleate, alkylsilane, arylsilane, alkenylsilane, alkynylsilane, benzotriazole, compounds comprising a 1,4-ene-yne structural unit, compounds comprising a 1,3-ene-yne structural unit, such as 2-methyl-1-hexene-3-yne, ethyl-3-(trimethylsilyl)propynoate, bis(phenylethynyl)dimethylsilane, diynes, such as decadiyne or dodecadiyne, polyynes, dienes, polyenes, such as decatriene, (1,3-dioxane-2-ylethnyl)trialkylsilane, 1,4-divinyltetramethyldisilylethane, amines, phosphanes, aliphatic or aromatic alkyne compounds can also be employed.

Reinforcing fillers (k) preferably employed in components A and/or B include highly dispersed active fillers, such as titanium dioxide, aluminum oxide, zinc oxide, preferably wet-precipitated or pyrogenic silicic acid, which may be in a hydrophilic or hydrophobized form; or mineral fibrous fillers, such as wollastonite, or synthetic fibrous fillers, such as glass gibers, ceramic fibers or plastic fibers. The BET surface area of these substances is preferably>50 m²/g.

Non-reinforcing fillers (I) preferably employed in components A and/or B include metal oxides, metal oxide hydroxides, mixed oxides or mixed hydroxides, preferably silica, especially in the form of quartz and its crystalline modifications, fused silica, alumina, calcium oxide, aluminum hydroxide, calcium carbonate, kieselguhr, diatomaceous earth, talcum, ground glasses and plastic-based fillers, for example, polymethyl methacrylate, polycarbonate, polyvinyl chloride, silicone resin powder, or powder based on fluoro-organic compounds, the non-reinforcing fillers also being employed in a surface-treated (coated) form. The surface treatment may be done, for example, with silanes and fatty acids which may contain functional groups (e.g., vinyl, allyl, —SiH). Also useful as non-reinforcing fillers are organic or inorganic hollow spheres, solid spheres and fibers. Solid or hollow plastic particles, e.g., also in spherical shapes, on the surface of which inorganic filler articles are embedded, may also be employed. Preferably, the BET surface area of the non-reinforcing fillers is<50 m²/g.

Preferred auxiliaries (m) which may be contained in components A and/or B include dyes, surfactants, opaque substances, plasticizers, hydrogen adsorbers/absorbers, radiopaque substances or organosilicon MQ resins comprising Si-vinyl, Si—OH, Si—OR⁰, Si-ethynyl and/or SiH groups.

Substances for adjusting the pH range may also be contained in components A and/or B. These preferably include acetic acid, citric acid, acetyltributyl citrate, ascorbic acid, acidic reinforcing or non-reinforcing fillers, acidic buffer systems, such as acetic acid/sodium acetate buffers or citric acid/citrate buffers, and alkaline reinforcing or non-reinforcing fillers, such as aluminum hydroxide, alkaline buffer systems, such as carbonate/hydrogencarbonate buffers, or alkaline or acidic ion-exchange resins.

The invention also relates to a mixture of the components. After the mixing of the components, the mixture according to the invention, in a first step, undergoes a transition from a lighter-bodied mixer-suitable initial consistency to a heavier-bodied plastic phase in which the material builds up a high force pressure in the making of dental impressions in the impression tray, and in a second step, cures to its final elastic form.

Preferred mixtures according to the invention have a mixer-suitable consistency, in a first state during and after mixing, of >26 mm, preferably >30 mm (according to ISO 4823), whereupon the mixtures undergo transition to a heavier-bodied second state with a consistency of <35 mm, preferably <30 mm (according to ISO 4823), caused by condensation reactions of SiOH groups and/or by hydrosilylation reactions of alkynyl groups with SiH groups. This latter consistency is maintained over a period of at least 15 s. Thereafter, the mixtures undergo transition to a third solid, elastic state following curing through a hydrosilylation reaction of alkenyl groups with SiH groups. The above reaction sequence can also be passed in reversed order.

For the two-step curable materials according to the invention, this means that the first reaction step, i.e., the transition from the mixer-suitable consistency of >26 mm, especially >30 mm, to a heavier-bodied consistency of <35 mm, especially <30 mm, can be time-controlled in such a way that the decrease in consistency (viscosity increase) takes place after the mixing period according to ISO 4823. In this way, for example, static or dynamic mixers of manual mixing or dosing systems do not become obstructed, for example, with kneadable impression material. Then, only immediately after leaving the mixer, the viscosity increase occurs through the first reaction step of the two-step reaction mechanism.

The invention encompasses the multicomponent mixtures after mixing, in a described states, and after curing. The mixture in the third, i.e., cured, state preferably meets the requirements demanded of an elastomeric impression material in the cured state according to ISO 4823, such as elastic recovery.

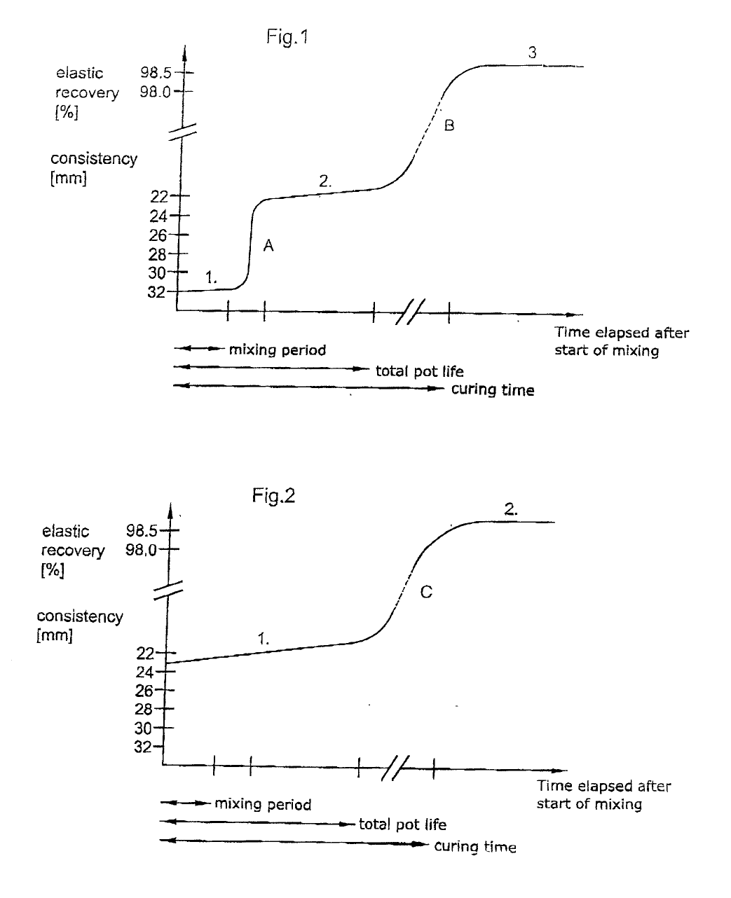

The change of consistency of a multicomponent mixture according to the invention is illustrated in FIG. 1:

In FIG. 1, the consistency in mm according to ISO 4823 Is plotted against the time elapsed after the mixing of components A and B. From the kinetics, two reaction steps A and B and three consistency states, which are relatively stable over some period of time, can be clearly distinguished:

1) 1st state, mixer-suitable consistency;

2) 2nd state, heavy-bodied or putty consistency until the end of the total pot life according to ISO 4823;

3) 3rd state, cured, solid, elastic state after curing time according to ISO 4823;

A) transition from the mixer-suitable to the heavy-bodied to putty consistency through a condensation reaction of the SiOH groups and/or hydrosilylation reaction between alkynyl and SiH groups;

B) transition from the heavy-bodied to putty consistency to the cured state through cross-linking by a hydrosilylation reaction between alkenyl and SiH groups.

In contrast, FIG. 2 shows the corresponding kinetics for the change in consistency of a putty material of the prior art. Here, only two consistencies, which are relatively stable for some time, can be distinguished; they are linked by a single reaction step:

1) 1st state, non-mixer-suitable consistency during the total pot life according to ISO 4823;

2) 2nd state, cured, solid, elastic state after curing time according to ISO 4823;

C) transition from the first, non-mixer-suitable consistency to the cured state through cross-linking by a hydrosilylation reaction between alkenyl and SiH groups.

The invention also relates to methods for the preparation of impressions from objects from which impressions are to be made.

In the method according to the invention, an impression material is first prepared by mixing the components A and B. The impression material is first dispensed in a first state from a container. Thereafter, it undergoes transition to a second state in which the viscosity of the impression material is clearly increased, whereupon an impression is prepared from an object from which an impression is to be made. Thereafter, the impression material undergoes transition to a third, solid state in which an impression result is recorded, the second state being achieved by graded hydrosilylation reactions between alkynyl and aikenyl structural units with compounds containing Si—H groups and/or by graded addition reactions (between alkenyl and SiH groups) and condensation reactions (of SiOH or SiOR⁰ groups with condensation catalysts).

Preferably, the consistency of the impression material in the first state is >26 mm, more preferably >30 mm, according to ISO 4823. In this first state, the impression material is mixer-suitable. The consistency of the impression material in the second state is especially <35 mm, especially <30 mm (according to ISO 4823), the impression material being heavier-bodied (more viscous) than it is in the first state. The impression material preferably remains in this second state until the end of the presettable total pot life, at least for 15 s. Preferably, the third, solid state is an elastic state.

With the present invention, it is possible to prepare support materials based on addition-cross-linkable polymers, especially polydimethylsiloxanes, for the making of dental impressions which can be dispensed from the recently developed automatic mixing and dosing systems, in this special case for curable two-component impression materials, due to their mixing consistency which is light to heavy-bodied in the initial phase, and after having left the mixing and dosing device, due to their two-step reaction mechanism, undergo transition to a mixing consistency with increased viscosity in a first reaction step after the mixing of the components.

This heavy-bodied to putty consistency is retained over a presettable period of time, especially over the pot life needed by the dentist.

Towards the end of the pot life, the impression material is introduced into the mouth. Now, the second reaction step starts, and the material cures completely. The cured product obtained has the mechanical properties of a cured dental impression material according to ISO 4823.

In this way, the requirements and advantages of a heavy-bodied to putty consistency support material are achieved while the mentioned drawbacks due to mixing and dosing errors and contamination are circumvented.

With the two-step curable mixer-suitable matenals according to the invention, it is possible to dispense kneadable materials from automatic mixing and dosing systems. The increase in viscosity by the two-step reaction mechanism can be controlled in such a way that a multicomponent impression material which is mixer-suitable at first and can be dispensed from manual and automatic mixing and dosing systems quickly undergoes transition to a kneadable consistency after the mixing period (according to ISO 4823). This kneadable consistency is retained until the end of the total pot life of the impression material.

The mixer-suitable multicomponent impression material according to the invention can be prepared in such a way that a kneadable impression material exhibits the tack-free behavior of a classical putty material after dispensing from a manual or automatic mixing or dosing system. Tack-free processing and spreading of the impression material with the finger is possible. In the sandwich shaping technique, the user can dent the necessary hollow with the finger without sticking.

Further, with another embodiment of the mixer-suitable impression materials according to the invention, it is possible to prepare particularly advantageous alginate substitute materials for the making of temporary impressions. Here, the heavy decrease in consistency (increase in viscosity) due to the first reaction step of the two-step reaction mechanism after dispensing from a manual or automatic mixing and dosing system is utilized for obtaining particularly non-sag and heavy-bodied consistencies.

This alginate-like consistency is retained during the whole pot life of the impression material according to ISO 4823 and makes it possible for the user to spread the material with the finger on the teeth from which an impression is to be made with no material sticking to the fingers, prior to introducing the impression tray.

The described transition of the mixtures from a first state to a second state of higher viscosity and further to a third, solid state according to the invention is achieved, inter alia, by the following preferred embodiments:

In an embodiment according to the invention, e.g., on a polysiloxane basis, the increase in viscosity of the impression material to a heavy-bodied or putty consistency is achieved by linking mainly a-monoethynylpolysiloxanes to the polymethylhydrogensiloxane by hydrosilylation. More vividly, a heavily branched “porcupine structure” is formed from the polymethylhydrogensiloxane chain by the “docking” therewith of the monoethynylpolysiloxanes. In this way, polymers having a very high molecular weight are constructed, but which do not exhibit any cross-linking between each other.

An addition of dialkynylpolysiloxanes can additionally enlarge the molecular weight jump to a high extent.

Once the majority of the alkynylpolydimethylsiloxanes, which react first, have reacted, the second reaction step begins after a pot life which can be preset by inhibitors.

In this step, the dialkenylpolysiloxanes react with the remaining SiH groups of the “porcupine polymer” which has become highly branched in the first step. In the dental application in the patient's mouth, this second step results in the cross-linking and complete curing of the elastomeric dental impression material.

By selectively using inhibitors, the respective kinetics can be controlled in the first and second reaction steps in accordance with the respective requirements of practice.

Another embodiment of the invention uses dialkynylpolysiloxanes for the first reaction step, The reaction of the dialkynylpolysiloxanes with an excess of linear dihydrogenpolysiloxanes to yield long linear polymer chains of high molecular weight causes the desired viscosity jump, which is equivalent to the transition from the first state to the second state.

Once the majority of the alkynylpolysiloxanes, which react first, have reacted, the second reaction step begins. In this step, branched polysiloxanes having at least three vinyl groups react with the SiH groups of the dihydrogenpolysiloxanes, which are now terminal to the polymer.

In the dental application in the patient's mouth, this second step results in the cross-linking and complete curing of the elastomeric dental impression material.

An addition of tri- or polyhydrogensiloxanes can additionally enlarge the molecular weight jump to a high extent.

In another embodiment of the invention, an exactly defined concentration of a dialkynylpolysiloxane reacts with a polyhydrogensiloxane, preferably having a high molecular weight (from 1000 to 450,000 g/mol) in a first reaction step. Due to the linking together, polysiloxanes having a high molecular weight are quickly constructed. In the behavior of the impression material, this is manifested by a viscosity jump according to the invention.

After all the ethynylsiloxanes have reacted, in a second reaction step, the excess SiH groups react with the available dialkenylpolysiloxanes. In the dental application in the patient's mouth, this second step results in the cross-linking and complete curing of the elastomeric dental impression material.

In the last three embodiments mentioned above, the first reaction step is a hydrosilylation between the alkynyl group and the SiH group. In this reaction step, only a slight cross-linking is permitted since otherwise elastic fractions will build already during the pot life. The elastic fractions formed would result in compressions (endogenous strains) during the pot life in the preparation of the impressions, which would eventually lead to non-fitting dental prostheses.

In another embodiment of the invention, an α,ω-dihydroxy- or dialkoxypolysiloxane reacts with a titanic acid ortho ester, such as titanium(IV) tetrapropylate, in a first reaction step. Due to the condensation reaction occurring, polysiloxanes having a high molecular weight are constructed relatively quickly. In the behavior of the impression material, this is manifested by a viscosity jump.

After the hydroxy- or alkoxysiloxanes have reacted, in a second reaction step, organohydrogensiloxanes react with the available dialkenylpolysiloxanes in a platinum-catalyzed addition reaction. In the dental application in the patient's mouth, this second step results in the cross-linking and complete curing of the elastomeric dental impression material. Of course, the mechanism described can also proceed in reversed order, i.e., first the addition and then the condensation, depending on the type and concentration of the catalysts and the type and concentration of the inhibitors employed.

In another embodiment of the invention, in a first reaction step, the alkynyl group of a dialkynylpolysiloxane reacts with a polyhydrogensiloxane, and an α,ω-dihydroxy- or dialkoxysilane reacts with a titanic acid ortho ester. Due to the alkyne addition reaction and the condensation reaction occurring, polysiloxanes having a high molecular weight are quickly constructed. In the rheological behavior of the impression material, this is manifested by a viscosity jump.

After the alkynyl groups and the hydroxy or alkoxy groups have reacted, in a further reaction step, organohydrogenpolysiloxanes react with the available dialkenylpolysiloxanes in a platinum-catalyzed addition reaction. In the dental application in the patient's mouth, this step results in the cross-linking and complete curing of the elastomeric dental impression material, Of course, the mechanism described can also proceed in reversed order with respect to the condensation reaction and the addition reaction with SiH and alkenyl, i.e., first the addition and then the condensation, depending on the type and concentration of the catalysts and the type and concentration of the inhibitors.

In a further embodiment according to the invention, e.g., on the basis of polysiloxanes, the increase in viscosity of the impression material to a heavy-bodied or putty consistency is achieved by mainly linking a-monohydroxypolysiloxanes, e.g., to the titanium alkoxide, by condensation. More vividly and plastically stated, a branched “porcupine structure” is formed from the titanium alkoxide by the “docking” therewith of the monohydroxypolysiloxanes. In this way, polymers having a very high molecular weight are constructed, but which do not exhibit any cross-linking between each other. An addition of dihydroxypolysiloxane can additionally enlarge the molecular weight jump to a high extent.

Once the majority of the hydroxypolydimethylsiloxanes, which react first, have reacted, the second reaction step begins after a pot life which can be preset by inhibitors.

In this step, the dialkenylpolysiloxanes react with the available SiH groups of the organohydrogenpolysiloxane. In the dental application in the patient's mouth, this second step results in the cross-linking and complete curing of the elastomeric dental impression material.

By selectively using inhibitors, the respective kinetics can be controlled in the first and second reaction steps in accordance with the respective requirements of practice.

If α-hydroxy-ω-vinylpolysiloxanes are employed instead of the monohydroxysiloxanes, the porcupine polymers formed can be incorporated in the polymer matrix in the second reaction step by hydrosilylation through the remaining freely available Si-vinyl groups.

### EXAMPLES

### Example 1

Kinetic examinations on model systems relating to the reaction rate of ethynyl and vinyl groups in the platinum-catalyzed hydrosilylation (according to the invention).

Design and performance of the kinetic experiments: GC analysis: 30 m FS capillary column, film 1.0 μm, covered with 100% polydimethylsiloxane (Econo-Cap capillary EC-1 of Alltech GmbH). Column preliminary pressure 0.35 bar of H₂. Temperature split injection and FID at 250° C.

Catalytic batch; Pt catalyst is charged first, addition of pentamethyidisiloxane, stirring at 33° C. for 20 to 40 min. Injecting the unsaturated substrate. Sampling of 1 ml samples at the respective reaction time to be examined, dilution with 4 ml of a TMEDA solution (containing 0.5 mmol of TMEDA/4 ml) for quenching the reaction. Injecting 1 μl of this solution for GC analysis.

a) Kinetic examination of the hydrosilylation of vinyltrimethylsilane

According to the method described above, 0.5 g (5 mmol) of vinyltrimethylsilane is reacted with 1.5 g of pentamethyidisiloxane (10 mmol) in 5.2 g of trimethylsilyl-end-stopped polydimethylsiloxane (MD₁₄M) as a solvent in the presence of 0.1 mg of platinum catalyst (in the form of divinyltetramethyidisiloxane-platinum complex, 1% in xylene), which corresponds to a pure platinum content of 50 ppm. The course of the reaction cannot be followed by GC analysis since the vinyltrimethylsilane has completely reacted after about 30 s with superheating.

b) Kinetic examination of the hydrosilylation of ethynyltrimethyisilane

According to the method described above, 0.5 g (5 mmol) of ethynyltrimethylsilane is reacted with 3.0 g (20 mmol) of pentamethyidisiloxane in 5.2 g of trimethylsilyl-end-stopped polydimethylsiloxane (MD₁₄M) as a solvent in the presence of 0.1 mg of platinum catalyst (employed in the form of divinyltetramethyldisiloxane-platinum complex, 1% in xylene), which corresponds to a pure platinum content of 50 ppm. The reaction mixture is examined by GC analysis at different times. Monoaddition and diaddition products are formed. After 1000 s, ethynyltrimethylsilane has been completely consumed to form 80% monoaddition product and 20% diaddition product. After 3 days at 35° C., the diaddition product has been formed at 98%.

c) Kinetic examination of the hydrosilylation of a mixture of ethynyltrimethylsilane and vinyltrimethylsilane

According to the method described above, a mixture of 0.3 g of vinyltrimethylsilane and 0.3 g of ethynyltrimethylsilane is reacted with 1.5 g of pentamethyldisiloxane in 5.2 g of trimethylsilyl-end-stopped polydimethylsiloxane (MD₁₄M) as a solvent in the presence of 0.1 mg of platinum catalyst (employed in the form of divinyltetramethyldisiloxane-platinum complex, 1% in xylene), which corresponds to a pure platinum content of 50 ppm. In this reaction, ethynyltrimethylsilane is consumed more quickly than vinyltrimethylsIlane. After 600 s, the whole ethynyltrimethylsilane has been consumed to form 80% monoaddition product and 20% diaddition product. In contrast, the partial reaction between vinyltrimethylslane and pentamethyidisiloxane is clearly decelerated as compared with Example 1a). After 1500 s, the whole vinyltrimethylsilane has been consumed.

Discussion of the results of the kinetic examinations from Examples 1 a) to c):

In the individual experiment, the hydrosilylation of ethynyltrimethylsilane proceeds more slowly than the hydrosilylation of vinyltrimethylsilane (Examples 1a and 1b).

When a mixture of ethynyltrimethylsilane and vinyltrimethylsilane is employed for hydrosilylation (Example 1c), ethynyltrimethylsilane reacts preferably at first. This is due to the fact that ethynyltrimethylsilane coordinates to the platinum more firmly or more quickly as compared to vinyltrimethylsilane. A notable reaction of vinyltrimethylsilane occurs only when the ethynyltrimethylsilane has been consumed almost completely.

According to the invention, this two-step course of the reaction can be utilized for the preparation of two-step curable silicone materials by using the hydrosilylation of ethynyl groups for the construction of high molecular weights or viscosities and using the time-shifted hydrosilylation of vinyl groups for cross-linking.

### Example 2

Behavior of ethynyltrimethylsilane as a model compound in an addition-cross-linkable silicone material (according to the invention).

a) In a mixer, 2 parts of ethynyltrimethylsilane is dissolved with 38 parts of a vinyl-end-stopped polydimethylsiloxane having a viscosity of 1000 mPa's and a vinyl content of 0.13 mmol/g to obtain a colorless clear 5% solution,

b) In a mixer, 3 parts of the mixture prepared under a) is homogeneously compounded into 100 parts of component 2 (SiH component) of an uninhibited medium-bodied impression material.

c) 50 parts of component 2 prepared under b) is homogeneously mixed with 50 parts of component 1 (Pt component) of a medium-bodied impression material from a dual-chamber cartridge through a static mixer to obtain a medium-bodied impression material (according to DIN EN 24823) having a total pot life of one minute and a curing end of 2.5 minutes.

Example 2 demonstrates that Si-ethynyl groups in an addition-cross-linkable silicone material have no strongly inhibiting influence on the curing behavior. The concentration of ethynyl, being 1.5 mmol/100 g, was selected as would be necessary for adjusting the desired increase in molecular weight when monoethynylpolydimethylsiloxane was used. The transition from the medium-bodied to putty consistencies is concluded after one minute as judged by this model reaction.

### Example 3

Model experiments relating to two-step curable addition- and condensation-cross-linkable mixer-suitable silicone materials (according to the invention).

a) In a vacuum mixer, 196 parts of an α,ω-divinylpolydimethylsiloxane having a viscosity of 1000 mPa's (at 23° C.), a molecular weight of about 15,000 g/mol and a vinyl content of 0.13 mmol/g was homogeneously mixed with 2.5 parts of a platinum-siloxane complex dissolved in divinylpolydimethylsiloxane having a pure platinum content of 1% and 1.5 parts of titanium(IV) tetrapropylate to obtain a very light-bodied mixture having a viscosity of about 800 mpa's (at 23° C.), which represents component 1 of the addition- and condensation-cross-linkable silicone material curable in two steps according to the invention.

b) In a vacuum mixer, 113 parts of a polymethylhydrogensiloxane having a viscosity of 200 mPa's (at 23° C.), a molecular weight of about 7000 g/mol and an SiH content of 1.8 mmol/g was homogeneously mixed with 83 parts of an α,ω-dihydroxypolydimethylsiloxane having a viscosity of 2000 mPa's (at 23° C.), 0.34 part of 1,2-divinyltetramethyldisiloxane and 3 parts of α,ω-divinylpolydimethylsiloxane having a viscosity of 1000 mPa's (at 23° C.) to obtain a very light-bodied mixture having a viscosity of 500 mPa's (at 23° C.), which represents component 2 of the addition- and condensation-cross-linkable silicone material curable in two steps according to the invention.

c) On a mixing block, 3 parts of component 1 from Example 3 a) and 1 part of component 2 from Example 3 b) are mixed within 30 s using a mixing spatula. The material undergoes an increase in viscosity within a short period of time. Immediately after the mixing, the viscosity of the mixture is 20,000 mpa's. This high viscosity is retained over a period of about five minutes. Towards the end of this pot life, the second reaction step starts, and the material cures at room temperature within 12 minutes.

This Example illustrates that it is possible to form a two-step reaction mechanism with the composition according to the invention, whereby a mixer-suitable material, which is very light-bodied at first, undergoes a transition, through a viscosity jump, to a heavier-bodied material which, in a second reaction step, cross-links to form an elastomeric solid after a reasonable pot life.

According to the invention, this behavior can be utilized for the preparation of heavy-bodied to kneadable impression materials which can be easily dispensed from commercially available mixing and dosing devices. Surprisingly, it is found in Example 3c according to the invention that the addition of water is not required for the reaction of the condensation cross-linker with the polymers having SiOH groups. In contrast, even a slight addition of water prevents the occurrence of a viscosity jump. In contrast, with the systems for (dental) impression materials known from the literature, the addition of water is required (“Silicone: Chemie und Technologie”, Vulkan Verlag Essen 1989, p. 55; W. Noll, “Chemie und Technologie der Silicone”, 2nd ed., Verlag Chemie 1968, page 340).

The preparation of corresponding two-step curable impression materials is described in Examples 4 and 5.

### Example 4

Formulations of two-step curable addition-cross-linkable and condensation-cross-linkable mixer-suitable silicone materials (according to the invention).

a) In a kneader, 67 parts of silica flour, 1 part of highly dispersed silicic acid having a BET surface area of 200 m²/g and 2 parts of a molecular sieve are homogeneously mixed with 8 parts of mineral oil having a viscosity of 200 mpa's, 0.5 part of a Pt-siloxane complex dissolved in divinylpolysiloxane having a pure platinum content of 1.0%, 21.0 parts of a vinyl-end-stopped polydimethylsiloxane having a viscosity of 1000 mPa's (at 23° C.) and 0.5 part of titanium(IV) tetrapropylate.

b) In a kneader, 67 parts of silica flour, 1 part of highly dispersed hydrophobized silicic acid having a BET surface area of 200 m²/g and 2 parts of a molecular sieve are homogeneously mixed with 8 parts of mineral oil having a viscosity of 200 mPa's (at 23° C.), 5 parts of a polymethylhydrogensiloxane having a molecular weight of about 7000 g/mol and an SiH content of 1.8 mmol/g and 7 parts of a divinylpolydimethylsiloxane having a viscosity of 1000 mPa's (23° C.) and a vinyl content of 0.13 mmol/g, and 10 parts of α,ω-dihydroxypolydimethylsiloxane having a viscosity of 2000 mPa's and an SiOH content of 0.1 mmol/g to obtain a medium-bodied paste, which represents component 2 (SiH component) of the silicone material curable in two steps according to the invention.

c) From a dual-chamber cartridge, 50 parts of component 1 from Example 4 a) and 50 parts of component 2 from Example 4 b) are homogeneously mixed through a static mixer using a dosing pistol. Since the impression material, in the form of its separated components, has a medium-bodied consistency, it can be easily dispensed through known electrically, pneumatically or manually operated mixing and dosing systems (Mixpac, EP 0 615 787 A1). Immediately after mixing, i.e., after the dispensing from the mixing and dosing system, the first reaction step starts.

Within a short period of time, the material undergoes an increase in viscosity and undergoes transition to a putty consistency according to ISO 4823 preimpression material. This putty consistency is retained over some period of time. Towards the end of the pot life, the impression material is introduced into the patient's mouth. Now, the second reaction step starts, and the material cures completely. The cured product obtained has the mechanical properties of a putty material according to ISO 4823.

### Example 5

Formulations of two-step curable addition-cross-linkable and condensation-cross-linkable mixer-suitable silicone materials (according to the invention).

a) In a kneader, 67 parts of silica flour, 1 part of highly dispersed silicic acid having a BET surface area of 200 m²/g and 2 parts of a molecular sieve are homogeneously mixed with 8 parts of mineral oil having a viscosity of 200 mPa's, 6 parts of α,ω-diethynylpolydimethylsiloxane having a viscosity of 1000 mPa's, a molecular weight of about 15,000 g/mol and an ethynyl content of about 0.13 mmol/g and 15 parts of α,ω-divinylpolydimethylsiloxane having a viscosity of 1000 mPa's, a molecular weight of about 15,000 g/mol and a vinyl content of 0.13 mmol/g, 0.5 part of a platinum-siloxane complex dissolved in vinylsiloxane having a pure platinum content of 1% and 0.5 part of titanium(IV) tetrapropylate to obtain a medium-bodied paste, which represents component 1 of the silicone material curable in two steps according to the invention.

b) In a kneader, 67 parts of silica flour, 1 part of highly dispersed hydrophobized silicic acid having a BET surface area of 200 m²/g and 2 parts of a molecular sieve are homogeneously mixed with 8 parts of mineral oil having a viscosity of 200 mPa's, 6 parts of polymethylhydrogensiloxane having a molecular weight of 7000 g/mol and an SiH content of 1.8 mmol/g and 6 parts of an α,ω-divinylpolydimethylsiloxane having a viscosity of 1000 mPa's, a molecular weight of about 15,000 g/mol and a vinyl content of 0.13 mmol/g, and 10 parts of an α,ω-dihydroxypolydimethylsiloxane having a viscosity of 2000 mPa's (at 23° C.) to obtain a medium-bodied paste, which represents component 2 of the addition-cross-linkable and condensation-cross-linkable silicone material curable in two steps according to the invention.

c) From a dual-chamber cartridge, 50 parts of component 1 from Example 5 a) and 50 parts of component 2 from Example 5 b) are homogeneously mixed through a static mixer using a dosing pistol. Since the impression material, in the form of its separated components, has a medium-bodied consistency, it can be easily dispensed through known electrically, pneumatically or manually operated mixing and dosing systems (Mixpac, EP 0 615 787 A1). Immediately after mixing, i.e., after the dispensing from the mixing and dosing system, the first reaction step starts. Within a short period of time, the material undergoes an increase in viscosity and undergoes transition to a putty consistency according to ISO 4823. This putty consistency is retained over some period of time. Towards the end of the pot life, the impression material is introduced into the patient's mouth. Now, the second reaction step starts, and the material cures completely. The cured product obtained has the mechanical properties of a putty material according to ISO 4823.

The results are discussed in connection with Example 6.

### Example 6

Formulations of two-step curable addition-cross-linkable and condensation-cross-linkable mixer-suitable silicone materials (according to the invention).

a) In a kneader, 47 parts of silica flour and 15 parts of highly dispersed hydrophobized silicic acid having a BET surface area of 200 m²/g are homogeneously mixed with 18 parts of mineral oil having a viscosity of 200 mPa's, 15 parts of vaseline, 3 parts of a platinum-siloxane complex dissolved in vinylsiloxane having a pure platinum content of 1% and 2 parts of titanium(IV) tetrabutylate to obtain a medium-bodied paste, which represents component 1 of the silicone material curable In two steps according to the invention.

b) In a kneader, 66 parts of silica flour and 2.5 parts of highly dispersed hydrophobized silicic acid having a BET surface area of 200 m²/g are homogeneously mixed with 7 parts of polymethylhydrogensiloxane having a molecular weight of 7000 g/mol and an SiH content of 1.8 mmol/g and 17 parts of an α,ω-divinylpolydimethylsiloxane mixture having a viscosity of 1200 mPa's and a vinyl content of 0.13 mmol/g, 4 parts of an α-hydroxy-ω-vinylpolydimethylsiloxane having a viscosity of 5000 mPa's and 2 parts of an α,ω-dihydroxypolydimethylsiloxane having a viscosity of 5000 mPa's (at 23° C.) to obtain a medium-bodied paste, which represents component 2 of the addition-cross-linkable and condensation-cross-linkable silicone material curable in two steps according to the invention.

c) From a dual-chamber cartridge, 1 part of component 1 from Example 6 a) and 5 parts of component 2 from Example 6 b) are homogeneously mixed through a static mixer using a dosing pistol. Since the impression material, in the form of its separated components, has a medium-bodied consistency, it can be easily dispensed from cartridges and tubular film bags through known electrically (Espe, Pentamix, EP 0 492 413 D1; DMG, Mixstar, DE 10013812 A1, Mixpac EP 0 956 908 A1) pneumatically or manually operated mixing and dosing systems (Mixpac, EP 0 615 787 A1). Immediately after mixing, i.e., after the dispensing from the mixing and dosing system, the first reaction step starts. Within a short period of time, the material undergoes an increase in viscosity and undergoes transition to a putty consistency according to ISO 4823. This putty consistency is retained over some period of time. Towards the end of the pot life, the impression material is introduced into the patient's mouth. Now, the second reaction step starts, and the material cures completely. The cured product obtained has the mechanical properties of a putty material according to ISO 4823:

| | |
|---|---|
| deformation under pressure: | 2.5% |
| elastic recovery: | 99.4% |
| linear dimensional change: | −0.2% |
| Shore A hardness (DIN 53505): | 70 |
| tensile strength at break (DIN 53504): | 160 N/cm² |

Discussion of Examples 5 and 6:

In the combination according to the Invention of the addition cross-linking of alkenyl with SiH and the condensation reaction of SIOH or SiOR⁰ with metal alkoxides with or without the addition of alkynyl with SiH as described in Examples 5c and 6c, it is found that the addition reaction and the condensation reaction proceed practically independently of each other and have no mutual negative influence on each other. Surprisingly, the reaction between SiOH and SiH in the presence of platinum with evolution of hydrogen (formation of gas bubbles) to be expected by one skilled in the art and known from the literature (“Silicone: Chemie und Technologie”, Vulkan Verlag Essen 1989, p. 55; W. Noll, “Chemie und Technologie der Silicone”, 2nd ed., Verlag Chemie 1968, page 340) is not observed.

The above-mentioned combination according to the invention shows a linear dimensional change according to ISO 4823 which is on the same order as with the commercially available addition-cross-linkable silicones. The linear dimensional change is between −0.1% and −0.3% while the commercially available condensation-cross-linkable silicones have values of between −0.6% and −1.5% (J. Wirz “Abformung in der zahnärtlichen Praxis, Gustav Fischer Verlag 1993, p. 56, 57; Dr. Wostmann, “Zum derzeitigen Stand der Abformung in der Zahnheilkunde”, Habilitationsschrift, University of Münster, Germany, p., 18ff). Example 6c according to the invention exhibits a linear dimensional change of 0.2%.

The separated components of Examples Sa and 6a, which comprise a cross-linking agent/catalyst combination consisting of metal alkoxides, especially titanates and hydrosilylation catalysts, especially Pt complexes, show a high storage stability in suitable primary packages both at room temperature and in thermal stress test conditions at 60° C. In this way, the minimum storage time of a commercial product of 6 months as required in practice is met.

In the composition according to the invention, the condensation cross-linking agent contained in the separated components of Examples 5a and 6a (metal alkoxides, especially titanates) has a high storage stability sufficient for practical conditions in a suitable primary package, such as aluminum-coated tubular film bags or water-vapor-impermeable plastic cartridges. This means that the activity of the condensation-cross-linking metal -alkoxides, especially titanates, results in a sufficient increase in molecular weight and the associated viscosity jump despite of the potential presence of water traces. In this way, the minimum storage time of a commercial product of 6 months as required in practice is met.

Surprisingly, the separated components of Examples 5b and 6b in which polymers having SiH and SiOH groups coexist do not show any reaction to make Si—O—Si linkages with cleavage of hydrogen either at room temperature or under thermal stress conditions at 60° C., i.e., an increase in viscosity of the above mentioned separated components or expansion of the primary package by hydrogen gas could not be observed.

### Example 7

Comparative Example: commercially available kneadable preimpression material (not according to the invention)

The commercially available putty materials Panasil Putty (Kettenbach #7399) and Provil novo putty fast set (Heraeus-Kulzer, lot No. 090554/090439), respectively separated into components 1 and 2, are filled into dual-chamber cartridges (EP 0 723 807 A2) or tubular film bags (cf. EP-A-0 541 972, PCT/EP 98/01993).

Due to the high discharging forces, dispensing of the above mentioned putty materials from the dual-chamber cartridge with a dosing pistol (Mixpac) through a static mixer (Mixpac MA 7,5-12-D) and filling of a commercially available impression tray is not possible within the total pot life according to ISO 4823.

Due to the high discharging and frictional forces, dispensing of the above mentioned putty materials from a tubular film bag using an electrically operated mixing and dosing device (Mixpac Type BD 400-230-0000, Serial No. Vorserie 00029, EP 0 956 908 A1; Espe, Pentarnix 2; EP-A-0 492 413) through a dynamic mixer (EP-A-0 492 412) and filling of a commercially available impression tray is not possible within the total pot life.

This Example illustrates that a commercially available putty material cannot be processed with automatic mixing and dosing systems, which is in contrast to the impression material according to the invention.

### Example 8

Comparative Example: commercially available putty cartridge material (not according to the invention)

The commercially available product Reprosil Quixx Putty of Dentsply Caulk is examined; on its package slip, the following statement is made:

“After dispensing from a dual-chamber cartridge using a static mixer, it undergoes a transition from an immediate mixing viscosity through a tray viscosity to a putty viscosity one minute after the start of mixing.” The ideal putty viscosity is achieved after from 1 minute and 15 seconds to 1 minute and 30 seconds. During this time window, the material behaves like a traditional putty material.

The above-mentioned commercial product is an addition-cross-linkable silicone known from the prior art, i.e., siloxane polymers with vinyl groups react with hydrogenpolysiloxanes, which results in cross-linking.

This means that the viscosity continuously increases due to the proceeding cross-linking without retaining a putty-like consistency (in contrast to the two-step reaction mechanism according to the invention).

This results in the following consequences:

The time window in which the putty consistency is retained is extremely short and therefore difficult to calculate for the user (dentist) (e.g., influence of external temperature on kinetics).

The short time window of 15 seconds involves the following risks:

When the predetermined time of 1 minute and 15 seconds is not yet reached, e.g., after one minute, the mixing consistency is not yet sufficiently high so that only a low pressure is built by the impression material when the impression is made.

When the predetermined time of 1 minute and 30 seconds is exceeded, the cross-linking is already very much advanced so that the elastic properties are predominant over the plastic properties and thus the risk of endogenous strains and compressions is extremely high when the impression is made.

This necessarily results in unacceptable impression results.

In addition, in the defined time window of from one minute and 15 seconds to one minute and 30 seconds, the commercial product Reprosil Quixx Putty does not show the kneadable and non-tacky properties familiar from the traditional putty when handled between the fingers, but it behaves like a medium-bodied impression material which cures according to the one-step hydrosilylation mechanism and exists in a transition from the plastic to the elastic state. It gives a tacky feel between the fingers.

Examples 3 to 5 demonstrate that it is possible, using the silicone materials having the composition according to the invention, to provide a material which, in the form of its separated components, has a light- to heavy-bodied consistency, can be easily dispensed by known electrically, pneumatically or manually operated mixing and dosing systems and undergoes an increase in viscosity within a short period of time (i.e., the consistency of the impression material after mixing according to ISO 4823 undergoes a transition from a light-bodied consistency (type 3) or medium-bodied consistency (type 2) to a heavy-bodied consistency (type 1) or putty consistency (type 0), or from a heavy-bodied consistency (type 1) to a putty consistency (type 0)).

The silicone material according to the invention combines the advantages of putty cartridge materials, such as suitability for automatic mixing and dosing, with the advantages of the classical kneadable support materials, such as building of force pressure during the making of the impression, non-tackiness in the putty-like state, and a reasonable total pot life, due to a two-step reaction mechanism and thus avoids the above mentioned drawbacks of the support materials of the prior art.

### Example 9

In order to define the concept of “mixer-suitable” more precisely, the discharge-ability of prior art materials was determined Dischargeability was determined for 7 materials, each with an automatic and a manual mixing and dosing system. The results are summarized in Table 1.

TABLE 1
Mixer-suitability of prior art materials

| Type of | Consistency | Dischargeability | Dischargeability |
|---|---|---|---|
| material | of mixture | from automatic | from manual |
| according to | according to | mixing and | mixing and |
| ISO 4823 | ISO 4823 | dosing systems¹⁾ | dosing systems²⁾ |
| putty³⁾ | 22 mm | not dischargeable | not dischargeable |
| putty⁴⁾ | 24 mm | not dischargeable | not dischargeable |
| heavy-bodied⁵⁾ | 26 mm | very hardly | not dischargeable |
| | | dischargeable | |
| heavy-bodied⁶⁾ | 28 mm | hardly dischargeable | not dischargeable |
| heavy-bodied⁷⁾ | 30 mm | acceptable | very hardly |
| | | | dischargeable |
| heavy-bodied⁸⁾ | 32 mm | acceptable | hardly dischargeable |
| heavy-bodied⁹⁾ | 34 mm | acceptable | acceptable |

¹⁾Pentamix 1, Espe, dynamic mixer, cartridge with tubular film bag; Pentamix II, Espe, dynamic mixer, cartridge with tubular film bag; Mixstar, DMG, dynamic mixer, cartridge with tubular film bag; BDG 400 Bulk Dispenser (prototype), Mixpac, dynamic mixer, cartridge CDB 400-01-V02;
²⁾System S 50, Mixpac, static mixer MB 7,5-11-D, cartridge CS 050-01-09, dispenser DS 50-01-00; System 50, Mixpac, static mixer MA 7,5-12-D, cartridge CD 051-01-09, dispenser DM 51-KE-1 l, TZAH, static mixer 190-712 D, cartridge BS-101-01, dispensing pistol DK-104;
³⁾Panasil Putty regular set, Kettenbach;
⁴⁾Panasil Putty soft, Kettenbach;
⁵⁾experimental product Panasil Plus heavy, Kettenbach;
⁶⁾experimental product Panasil Plus heavy, Kettenbach;
⁷⁾experimental product Panasil Plus heavy, Kettenbach;
⁸⁾Panasil Tray fast set, Kettenbach;
⁹⁾Kettosil, Kettenbach.

### Example 10

Table 2 sets forth the dispensed quantity of different commercial products as compared to the impression material according to the invention, e.g., according to Example 6 c), with different dispensing devices.

Further, the mixture consistencies and the properties of “kneadability” and “tackiness” are evaluated.

From Table 2, it can be seen that only Example 6 c) according to the invention has an extremely low mixture consistency, is kneadable and non-tacky, but nevertheless can be dispensed from commercially available dispensing devices in a quantity suitable for practice.

TABLE 2

| | dispensed quantity in | | | | | |
|---|---|---|---|---|---|---|
| Supplier: | g/min; dispensing device: | | | Consistency¹⁾ of | | |
| product and lot | Mixstar^{a)} | Penta I^{b)} | Penta II^{c)} | the mixture in mm | kneadable²⁾ | tacky³⁾ |
| Espe: Permadyne Penta H, | 48.6 | 57 | 82.4 | 32 | no | yes |
| Kat 551, Base 270, Pentamatic | | | | | | |
| Espe: Impregum Penta, | 47.8 | 56.4 | 82.6 | 35 | no | yes |
| Kat N80, Base E30, Pentamatic | | | | | | |
| Espe: Dimension Penta H, | 69.6 | 81 | 121.6 | 28 | no | yes |
| Kat 459, Base 094 | | | | | | |
| Dentsply: Aquasil heavy body | 57.6 | 68 | 93.6 | 29 | no | yes |
| Kat 000327, Base 0003000367 | | | | | | |
| Coltene: President heavy body | 58.2 | 69.4 | 92.2 | 29 | no | yes |
| Kat 07, Base 11 | | | | | | |
| Kettenbach: Panasil Tray fast | 63 | 75.6 | 118.6 | 32 | no | yes |
| Kat 00021, Base 00021 | | | | | | |
| Example 6c) according to the | 54 | 67 | 103 | 22 | yes | no |
| invention | | | | | | |

^{a)}Ser. No.: 99-678, ^{b)}Ser. No.: 535617, Espe; ^{c)}Ser. No.: 5106647, Espe
¹⁾Determination according to ISO 4823; ²⁾the material can be kneaded between the fingers immediately following machine-operated dispensing; ³⁾i.e., it is not possible to knead the material immediately following the mixing process due to its tackiness.

1. A multi-component system for making impressions, characterized by containing
(a) at least one compound having at least two alkenyl groups;
(b) at least one compound having at least one alkynyl group and/or at least one compound having at least one Si-OH structural unit;
(c) at least one organohydrogenpolysiloxane;
(d) at least one condensation catalyst and/or condensation cross-linking agent; and
(e) at least one hydrosilylation catalyst.

2. A multi-component system for making impressions comprising at least two components A and B, characterized in that component A contains
(a) at least one compound having at least two alkenyl groups;
(b) at least one compound having at least one alkynyl group and/or at least one compound having at least one Si—OH structural unit; and
(c) at least one organohydrogenpolysiloxane;
and component B contains (d) at least one condensation catalyst and/or condensation cross-linking agent; and
(e) at least one hydrosilylation catalyst.

3. Component A according to claim 2, characterized by containing
(f) inhibitors of the condensation reactions of metal alkoxides with compounds containing Si-OH structural units; and/or
(g) water-donating agents.

4. Components A and/or B according to any of claims 2 and 3, characterized by additionally containing
(h) desiccants;
(i) Inert carrier materials;
(j) compounds for reaction inhibition of the hydrosilylation reaction;
(k) reinforcing fillers;
(l) non-reinforcing fillers; and/or
(m) auxiliaries.

5. Component A according to any of claims 2 to 4, characterized in that the alkynyl compound according to (b) is
R¹—C═C—X—R²
and the Si-OH compound according to (b) is 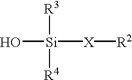
wherein
R¹=alkyl, aryl, arylalkyl, halogen-substituted alkyl and aryl groups, cyanoalkyl, cycloalkyl, cycloalkenyl, especially —H, —OH, alkoxy, acyl and combinations thereof; 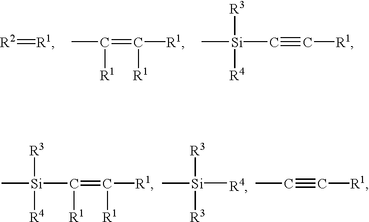
R³ alkenyl, alkynyl, halogen, aryl, alkylaryl, H, halogen-substituted alkyl and aryl groups, especially alkyl, aikoxy and hydroxy, and combinations thereof;
R⁴=R³, or R⁴ is different from R³, wherein R⁴ is, in particuiar, alkoxy, hydroxy, alkyl, methyl, alkynyl, ethynyl, or combinations thereof; and
X=polyslioxane, polyether, monomeric, oligomeric or polymeric hydro carbons, polyesters and copolymers of the above mentioned compounds.

6. Component A according to any of claims 2 to 5, characterized in that the compound according to (b) is 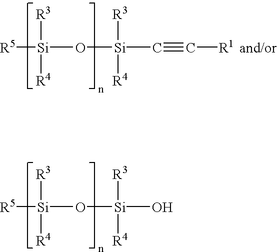
wherein n=0 to 6000;
R¹ to R⁴ are as defined in claim 4; and
R⁵=—C═C—R¹, H, alkyl, aryl, 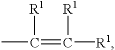
alkylaryl, halogen, OH, halogen-substituted alkyl and aryl groups, —OR⁰, aminoalkyl, epoxy, cyanoalkyl, cycloalkyl, alkylhydroxyl, methacrylate, acrylate, mercaptoalkyl, carboxylate, carboxyalkyl or succinic anhydride.

7. Component A according to any of claims 2 to 6, characterized by additionally containing a compound of the structural formula 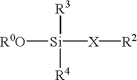
wherein
R⁰ is an acyl or alkyl residue; and
R², R³, R⁴ and X are as defined in claim 4.

8. Component A according to any of claims 2 to 7, characterized in that the alkenyl compound (a) is 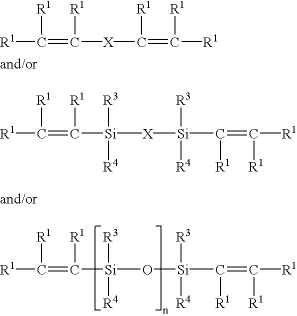
wherein n=0 to 6000; or
a silane dendrimer having terminal alkenyl groups;
wherein residues R¹, R²r R³ and R⁴ are as defined in claims 4 and 5.

9. Component A according to any of claims 2 to 8, characterized in that the organohydrogenpolysiloxanes (c) are polyalkyl-, polyaryl- and polyalkylaryl-, polyhaloalkyl-, polyhaloaryl- or polyhaloalkylarylsiloxanes, which are present in the form of oligomers or polymers in a linear or cyclic form and have at least one Si—H bond.

10. Component B according to claims 2 and/or 4, characterized in that the condensation catalysts and/or condensation cross-linking agents (d) are aluminum alkoxides, antimony alkoxides, barium alkoxides, boron alkoxides, calcium alkoxides, cerium alkoxides, erbium alkoxides, gallium alkoxides, germanium alkoxides, hafnium alkoxides, indium alkoxides, iron alkoxides, lanthanum alkoxides, magnesium alkoxides, neodymium alkoxides, samarium alkoxides, strontium alkoxides, tantalum alkoxides, titanium alkoxides, tin alkoxides, vanadium alkoxide oxides, yttrium alkoxides, zinc alkoxides, zirconium alkoxides, titanium or zirconium compounds, especially titanic and zirconic acid ortho esters, and double metal alkoxides, chelates and oligo- and polycondensates of the above alkoxides, dialkyltin diacetate, tin(II) octoate, dialkyltin diacylate or dialkyltin oxide.

11. Component B according to claims 2, 4 and/or 10, characterized in that the hydrosilylation catalysts (e) are transitior metals of the 8th auxiliary group, preferably platinum, palladium and rhodium or their salts, complexes and colloids, preferably platinum complexes and salts of hexachloroplatinic acid.

12. Component A according to any of claims 3 to 9, characterized in that the inhibitors of the condensation reactions (f) are α,ω-dihydroxydi-, -tri-, -oligo- and -polydialkylsiloxanes of general formula
HO—SiR₂—O—(SiR₂O)ₙ—SiR₃ or
HO—SiR₂—O—(SiR₂O)ₙ—SiR₂OH,
wherein R represents the same or different optionally substituted hydrocarbyl residues, such as alkyl, alkenyl, aryl or alkynyt, and n=0 or an integer of from 1 to 100.

13. Component A according to any of claims 3 to 9 and/or 12, characterized in that the water-donating agents (g) are inorganic fillers containing superficially bound residual moisture or water bound in the crystal lattice, zeolites, purposefully moistened fillers or organic substances having a defined water content.

14. Components A and/or B according to any of claims 4 to 13, characterized in that the desiccants (h) are zeolites, dried fillers or water-absorbing organic compounds, such as oxazolidines and alkali salts of poly(meth)acrylic acid (superabsorbers).

15. Components A and/or B according to any of claims 4 to 14, characterized in that the inert carrier materials (i) are mineral oils, branched hydrocarbons, vaseline, esters, phthalic acid esters, acetyltributyl citrate, polyalkylene oxides and polyesters and their copolymers.

16. Components A and/or B according to any of claims 4 to 15, characterized in that the compounds for reaction inhibition of the hydrosilylation reaction (j) are short-chained organopolysiloxanes of general formula
CH₂═CH—SiR₂O—(SiR₂O)ₙ—SiR₂—CH═CH₂,
wherein R represents the same or different optionally substituted hydrocarbyl residues, such as alkyl, alkenyl, aryl, alkynyl, alkenyl, and alkynyl-terminated siloxane residues; and
n=0 or an integer of from 1 to 6; or
vinyl-containing cyclic siloxanes, such as tetravinyltetramethyicyclotetrasiloxane, or organic hydroxy compounds containing terminal double or triple bonds, diethyl maleate, alkylsilane, arylsilane, alkenylsilane, alkynylsilane, benzotriazole, compounds comprising a 1,4-ene-yne structural unit, compounds comprising a 1,3-ene-yne structural unit, such as 2-methyl-1-hexene-3-yne, ethyl-3-(trimethylsilyl)propynoate, bis(phenylethynyl)dimethylsilane, diynes, such as decadiyne or dodecadiyne, polyynes, dienes, polyenes, such as decatriene, (1,3-dioxane-2-ylethynyl)trialkylsilane, 1,4-divinyltetramethyldisilylethane, amines, phosphanes, aliphatic or aromatic alkyne compounds.

17. Components A and/or B according to any of claims 4 to 16, characterized in that the reinforcing fillers (k) are highly dispersed active fillers, such as titanium dioxide, aluminum oxide, zinc oxide, preferably wet-precipitated or pyrogenic silicic acid, which may optionally be in a hydrophilic or hydrophobized form; or mineral fibrous fillers, such as wollastonite; or synthetic fibrous fillers, such as glass gibers, ceramic fibers or plastic fibers.

18. Components A and/or B according to any of claims 4 to 17, characterized in that the non-reinforcing fillers (I) are metal oxides, metal oxide hydroxides, mixed oxides or mixed hydroxides, preferably silica, especially in the form of quartz and its crystalline modifications, fused silica, alumina, calcium oxide, aluminum hydroxide, calcium carbonate, kieselguhr, diatomaceous earth, talcum, ground glasses and plastic-based fillers, for example, polymethyl methacrylate, polycarbonate, polyvinyl chloride, silicone resin powder, or powder based on fluoro-organic compounds, the non-reinforcing fillers optionally being surface-treated (coated).

19. Components A and/or B according to any of claims 4 to 18, characterized in that the auxiliaries (m) are dyes, surfactants, opaque substances, plasticizers, hydrogen adsorbers/absorbers, radiopaque substances or organositicon MQ resins comprising Si-vinyl, Si-OR⁰, Si-ethynyl and/or SiH groups, or compounds or buffers and substances for adjusting the pH range.

20. Mixtures obtainable by mixing the components A and B of claims 2 to 19.

21. The mixtures according to claim 20, characterized in that, after the mixing of the components, the mixture, in a first step, undergoes a transition from a lighter-bodied mixer-suitable initial consistency to a heavier-bodied plastic phase in which the material builds up a high force pressure in the making of dental impressions in the impression tray, and in a second step, cures to its final elastic form.

22. The mixtures according to claim 20, characterized in that said mixtures have been cured to completion.

23. The mixtures according to claim 20, characterized in that the mixtures have a mixer-suitable consistency, in a first state during and after mixing, of >26 mm, preferably >30 mm (according to ISO 4823), whereupon the mixtures undergo transition to a heavier-bodied second state with a consistency of <35 mm, preferably <30 mm (according to ISO 4823), caused by condensation reactions of SIOH groups and/or by hydrosilylation reactions of alkynyl groups with SiH groups, this latter consistency being maintained over a period of at least 15 s, and thereafter, the mixtures undergo transition to a third solid, elastic state following curing through a hydrosilylation reaction of alkenyl groups with SiH groups.

24. A method for the preparation of impressions from objects from which impressions are to be made using an impression material having a composition according to claim 1 and/or components A and/or B according to any of claims 2 to 19, wherein the impression material is first dispensable in a first state from a container, whereupon it undergoes transition to a second state in which the viscosity of the impression material is increased, whereupon an impression is prepared from an object from which an impression is to be made, whereupon the impression material undergoes transition to a third, solid state in which an impression result is recorded, the second state being achieved by graded hydrosilylation reactions between alkynyl and alkenyl structural units with compounds containing Si—H groups and/or by graded addition reactions (between alkenyl and SiH groups) and condensation reactions (of SiOH or SIOR⁰ groups with condensation catalysts).

25. The method according to claim 24, characterized in that the consistency of the impression material in a first state is >26 mm, preferably >30 mm (according to ISO 4823), and the impression material is mixer-suitable in this first state, that the consistency of the impression material in the second state is <35 mm, preferably <30 mm (according to ISO 4823), wherein the impression material is heavier-bodied than it is in the first state, and that the impression material in this second state is retained to the end of the total pot life, i,e., for at least 15 s.
